(19) United States
(12) Patent Application Publication
(10) Pub. No.: US 2010/0101086 A1
(43) Pub. Date: Apr. 29, 2010

(54) DEVICE AND PROCESS FOR RAPID DISASSEMBLY OF A ROTOR AND A NACELLE FROM THE MAST OF A WINDMILL, AS WELL AS A WINDMILL THAT IS EQUIPPED WITH SUCH A DEVICE

(75) Inventor: Raoul Amram, Paris (FR)

Correspondence Address: YOUNG & THOMPSON, 209 Madison Street, Suite 500, Alexandria, VA, 22314, US

(73) Assignee: EOLE OVERSEAS COMPANY LIMITED, Nicosia (CY)

(21) Appl. No.: 12/373,348

(22) PCT Filed: Jul. 6, 2007
(86) PCT No.: PCT/FR07/01161

§ 371 Date: Oct. 15, 2009

(30) Foreign Application Priority Data
Jul. 12, 2006 (FR) 0606368

(51) Int. Cl. B66C 23/18; B23P 11/00; B66C 23/26; B66C 23/24; B66C 13/40

(52) U.S. Cl. 29/889.1; 29/281.6; 212/179; 212/285

(57) ABSTRACT

A crane-bearing assembly (6) is formed by a crane (7) mounted on a bearing (8), wherein the crane-bearing assembly (6) is capable of displacement along the mast (1) using a lifting element (1-149 and an element for blocking the crane-bearing assembly (6) at the top of the mast (1). The crane-bearing assembly (6) is capable of sliding along guiding rails rigidly mounted on one side of the mast. The lifting element (11-14) is at least partially integrated into the mast and include a hoist (11) provided at the foot of the mast (1) and having a cable (12) passing through a first return pulley (13) rigidly connected to the top thereof.

The invention pertains to the field of windmills and relates more particularly to a device for rapid disassembly of a rotor and a nacelle from the mast of a windmill.

In addition, the invention relates to a windmill that is equipped with such a device, as well as a process for rapid disassembly of a rotor and a nacelle from the mast of a windmill.

The device for rapid disassembly according to the invention is primarily designed to be used in the event of a hurricane forecast so as to rapidly shelter the rotor and the nacelle of the windmill. The nacelle contains the generator of the windmill, whereas the rotor consists of a hub that is connected to the shaft of the generator and two or three fixed blades arranged at equal intervals around the hub. These are the most exposed and the most fragile elements of the windmill in the event of very strong winds.

Today, the windmill that has the best wind resistance can withstand linear winds of 180 km/h (50 m/s) and gusts that can reach up to 252 km/h (70 m/s) for approximately 3 seconds.

However, it is different with hurricane winds, which are more sustained winds and which, close to the eye of the hurricane, are turbulent, rising or descending. These hurricane winds are classified in the following manner:
Category 1: Winds reaching speeds of 118 to 152 km/h
Category 2: Winds reaching speeds of 153 to 176 km/h
Category 3: Winds reaching speeds of 177 to 208 km/h
Category 4: Winds reaching speeds of 209 to 248 km/h
Category 5: Winds reaching speeds of more than 248 km/h.

It is evident from the preceding that in the hypothesis where a hurricane of category 2, 3 and more is forecast, the only way to not expose the windmill to major risks consists in disassembling the rotor and the nacelle from the mast of the windmill, lowering it to the ground, and sheltering it from hurricane winds well before the hurricane arrives.

However, there is a relatively short period of time, not exceeding 96 hours, to carry out this disassembly, and the cranes that have been used in assembling the mast, the nacelle and the rotor are no longer quickly available on site.

We are thus confronted with a true problem that becomes even more critical if in addition the rotors and the nacelles are to be disassembled from several windmills, which is virtually always the case because the windmills are generally grouped in windmill parks.

Furthermore, if in addition the windmill(s) is/are located on an island or in mountainous regions or regions that are otherwise difficult to access for other reasons, we do not have any possibility of disassembling the rotor and the nacelle before the hurricane arrives, and the risk is too great of seeing the windmill(s) virtually destroyed.

An attempt has already been made to solve this problem of protecting the rotor and the nacelle, but without disassembly.

Thus, the document FR 2 832 784 proposes using a support mast in combination with a lifting mast. The two masts form an angle of approximately 90° relative to one another and are articulated at the same point on one base fixed on the ground. The lifting mast makes it possible to swing the support mast that carries the nacelle and the rotor to place these elements on the ground. However, this construction requires a very large free surface area in the swinging direction of the support mast.

In addition, with this device, the entire unit is to be as light as possible, which brings about the drawback of limiting the power of the generator. The strongest power that can be obtained with this technology is 275 kW, whereas the device according to the invention does not involve any limitation of this type and makes it possible to reach, and even exceed, a height of 120 m of the mast.

Another solution for protecting the rotor and the nacelle consists in making the mast of the windmill telescopic so as to be able to lower these elements toward the ground to disassemble them. However, such a solution is very difficult to implement and extremely expensive.

Even if a large number of devices that allow the assembly of a windmill and the mounting of a nacelle and a rotor at the top of the latter are known, these devices are not designed to allow at any moment the rapid disassembly of a rotor and a nacelle from the mast of a windmill.

Such is the case of the device that is described in DE 197 41 988 that relates to a crane-support unit that is used for the assembly of a windmill and that can be hoisted segment by segment toward the top using a cable that is hooked onto a holding eyelet that is fixed close to the upper edge of each segment. The crane-support unit is held against the mast by two U-shaped elements that surround the mast, and each comprises a pair of holding arms. This device can be difficult to use in an emergency situation. Furthermore, these lifting means with hook and eye without locking means in an upper position are not reliable.

A similar device is described in DE 196 47 515, which exhibits the same drawbacks.

Another device that is designed for the assembly of a windmill is known from JP 11082285, which describes the use of a “climbing” crane that moves upward segment by segment. However, this device is complex and heavy and cannot be used for the rapid disassembly of a rotor and a nacelle from the mast of a windmill.

Assembly devices that do not have a crane and that comprise a platform that can move along the mast of the windmill as a lifting means are also known from documents US 2002/171247 and U.S. Pat. No. 4,311,434. However, these devices are suitable only for the light windmill structures, generally lattice windmills.

Consequently, there is a very great need in hurricane regions for a simple and effective device that allows the quick disassembly of the rotor and the nacelle from the windmill upon the forecast of a hurricane of category 2, 3 or more.

The purpose of the invention is to eliminate this problem and the drawbacks of the known devices by proposing a device for rapid disassembly of a rotor and a nacelle from the mast of a windmill, whereby this device is permanently available on the site of the windmill so as to be able to immediately initiate the disassembly of the rotor and the nacelle to shelter them from hurricane winds. This device is also simple, reliable and easy to use.

One object of the invention is a device for rapid disassembly of a rotor and a nacelle from the mast of a windmill, comprising a crane-support unit that is formed by a crane that is mounted on a support, whereby said crane-support unit is able to move along the mast using lifting means, and locking means of said crane-support unit at the top of the mast, characterized by the fact that said crane-support unit is able to slide on guide rails fixed permanently on one side of the mast, and that said lifting means are at least partially integrated in the latter and comprise a winch that is arranged at the bottom of said mast and through which a cable runs over a first return pulley permanently fixed at the top of the latter.

According to other characteristics of the device according to the invention:
Said winch is placed inside the mast;
Said winch is a modular winch that can be fixed by rapid connecting means at a mounting point that is provided close to the mast of each windmill equipped with a device of the same type, and said cable extends through an opening in the lower part of the mast to first run over a second return pulley that is fixed permanently inside the mast, in the lower part of the latter;
Stop means are provided at the top and/or at the bottom of the mast so as to stop said crane-support unit in a locking position respectively to operate the descent of the rotor and the nacelle and/or in a position for separation of said crane-support unit from the mast;
Said rails exhibit a T-shape so as to accommodate, by means of mating shapes, C-shaped holding elements that are provided from one side of said support;
Said locking means comprise first locking elements that are provided on said support and that are able to work with second locking elements that are provided on said mast;
Said first and second locking elements comprise plates that extend beyond the periphery of said support respectively from said mast and that are provided with holes that can be aligned on one another when said support is found at the top of the mast, and locking rods that can be inserted into said aligned holes;
Said rods are controlled by hydraulic means that are part of an on-board hydraulic circuit on said support;
Said lifting means comprise a winch that is arranged at the bottom of said mast and through which a cable runs over a first permanent fixed return pulley at the top of the latter;
Said crane-support unit comprises means for controlling the crane that comprises remote control means that make it possible to control at a distance all of the functions of the crane;
Said remote control means also make it possible to control at a distance said means of locking said crane-support unit, at least for unlocking the latter;
Said crane-support unit is able to be placed without prior disassembly on a transport vehicle so as to be used on several windmills that are equipped with said rapid disassembly device.

Another object of the invention is a windmill that is equipped with such a device.

In addition, the invention has as its object a process for rapid disassembly of a rotor and a nacelle from the mast of a windmill. This process is characterized by the fact that it comprises the phases that consist in:
Providing on the windmill, during construction of the latter, guide rails that are permanently fixed on one side of the mast and are able to guide a unit that is formed by a crane that is mounted on a support;
Integrating in the mast, at least partially, lifting means of said crane-support unit comprising a winch that is placed at the bottom of said mast and from which a cable runs over a first pulley that is permanently fixed at the top of the mast;
Providing locking means of said crane-support unit at the top of the mast;
   and during said rapid disassembly of the rotor and the nacelle:
Connecting said crane-support unit to said rails at the bottom of the mast;
Hoisting said crane-support unit to the top of the mast using said lifting means;
Locking said crane-support unit at the top of the mast using said locking means;
Placing the jib of the crane above the rotor and connecting the latter to a cable of the jib;
Disengaging the rotor from the nacelle and lowering it using the crane to put it on the ground;
Placing the jib of the crane above the nacelle and connecting the latter to the cable of the jib;
Disengaging the nacelle from the mast and lowering it using the crane to put it on the ground;
   and, after the time the rotor and the nacelle have to remain on the ground:
Reassembling the nacelle and the rotor using the crane in reverse order.

According to other characteristics of the process according to the invention:

The process also comprises the phases that consist in:
Releasing said crane-support unit from said locking means to make it descend toward the ground while keeping the rotor and the nacelle on the ground;
Separating said crane-support unit from said guide rails.

The process also consists in:
Placing said crane-support unit on a transport vehicle;
Transporting said crane-support unit having at least one windmill of the same type and carrying out in the same way the disassembly of the rotor and the nacelle from the latter;

and after the time the rotor and the nacelle have to remain on the ground respectively:
Reassembling the nacelle and the rotor in reverse order by transporting said crane-support unit between the thus disassembled windmills.

According to the process, a modular winch that is part of said lifting means and is able to be fixed by rapid connecting means at a mounting point provided on the exterior of the mast of each windmill of the same type is used, and a second return pulley is permanently fixed on the inside of the mast, in the lower part of the latter, and a cable is passed from said modular winch through an opening at the bottom of the mast.

According to the process, all of the operations of the crane are remote-controlled.

Other characteristics and advantages will become evident from the following description of a non-limiting embodiment of the invention, with reference to the accompanying figures in which:

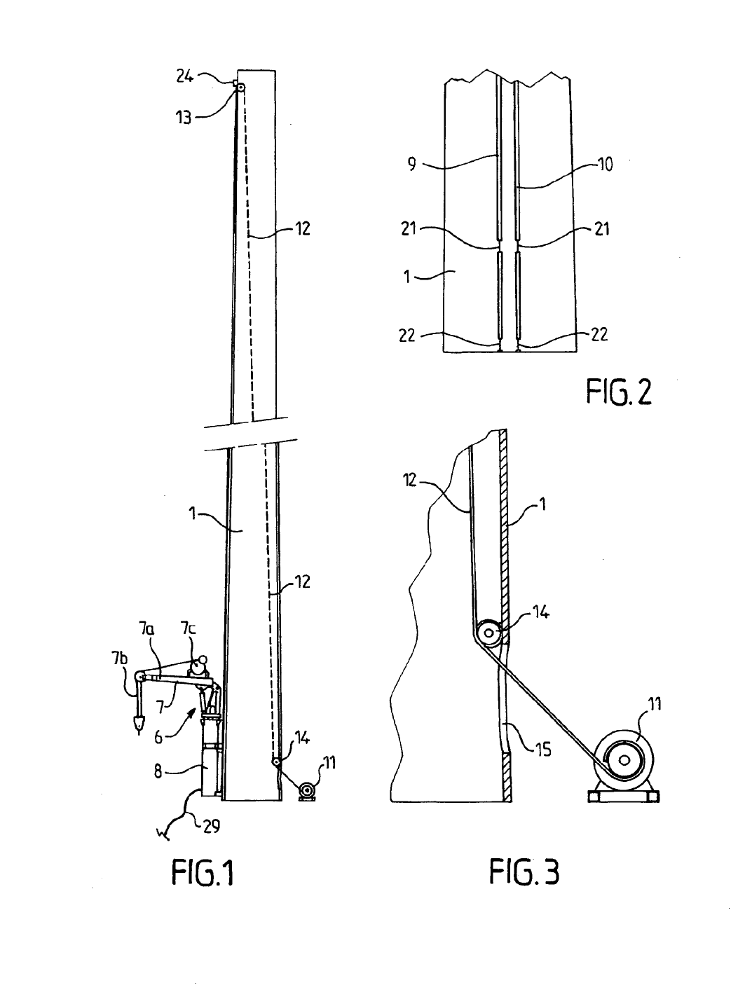

FIG. 1 is a diagrammatic lateral view that shows a windmill mast that is equipped with a rapid disassembly device according to the invention that comprises a crane-support unit in a low position;

FIG. 2 is a partial side view that shows the arrangement of the guide rails at the bottom of the mast of the windmill;

FIG. 3 is a partial cutaway view that shows the lower part of the mast of the windmill and a winch that is placed on the outside of the mast;

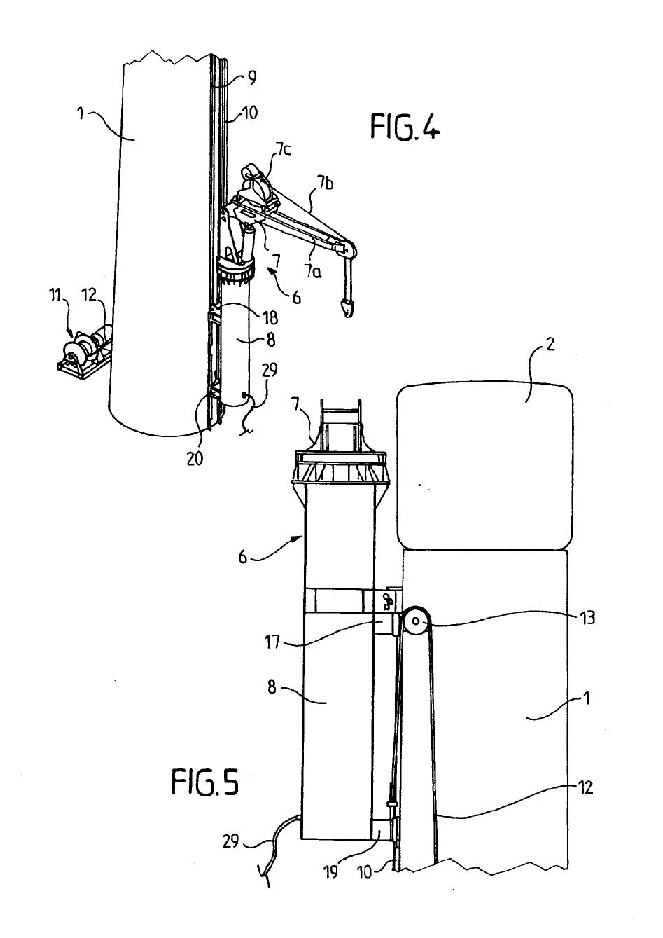

FIG. 4 is a partial perspective view that shows the crane-support unit according to the invention engaged on fixed rails of one side of the mast, as well as a winch that is placed on the outside of the mast on the side opposite to this crane-support unit;

FIG. 5 is a partial side view that shows the top part of the mast of the windmill with the nacelle and the crane-support unit in top position;

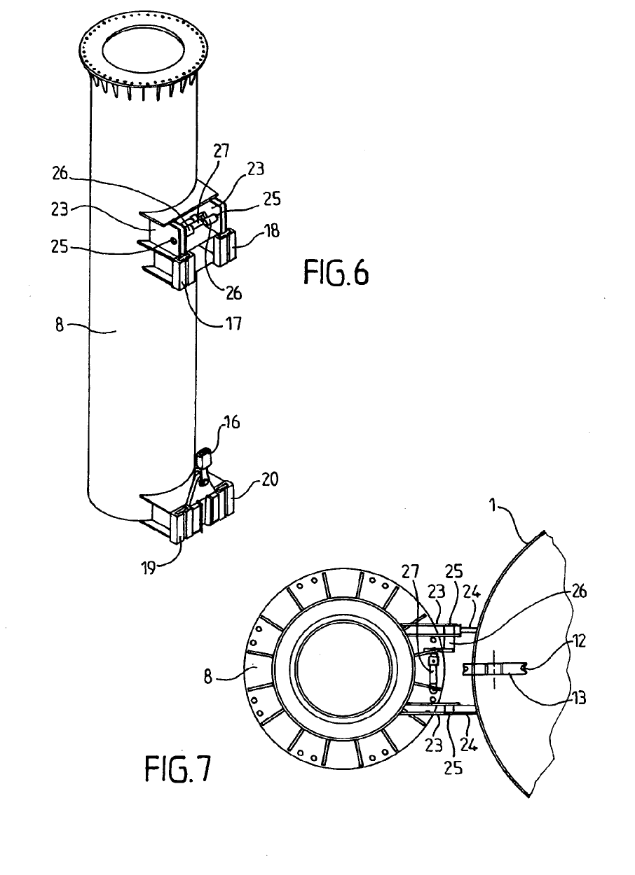

FIG. 6 is a perspective view that shows the crane support and its locking and guide device according to the invention;

FIG. 7 is a top view, partially in cutaway, showing the crane support in its top position and the means for locking the crane-support unit in this position;

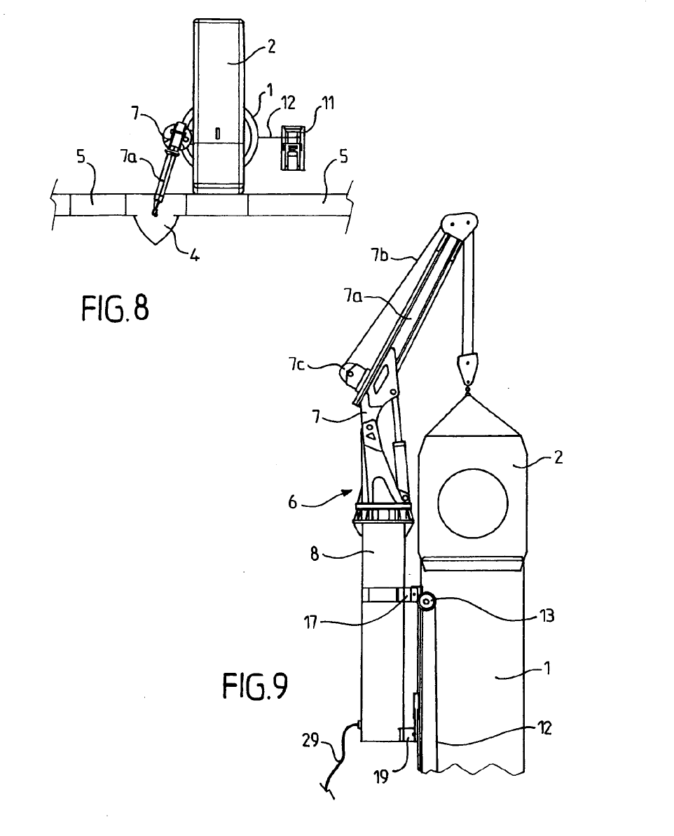

FIG. 8 is a top view that illustrates the position of the crane at the beginning of the descending operation of the rotor;

FIG. 9 is a side view that illustrates the position of the crane at the beginning of the disassembly operation of the nacelle;

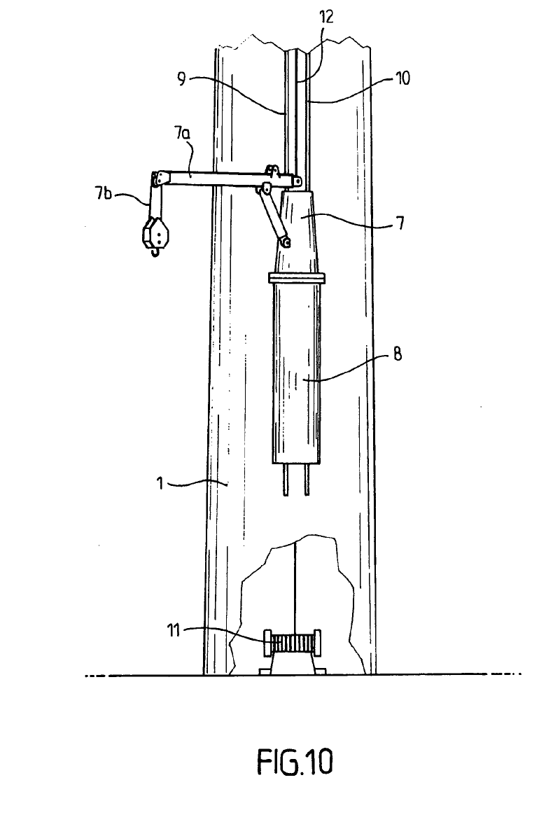

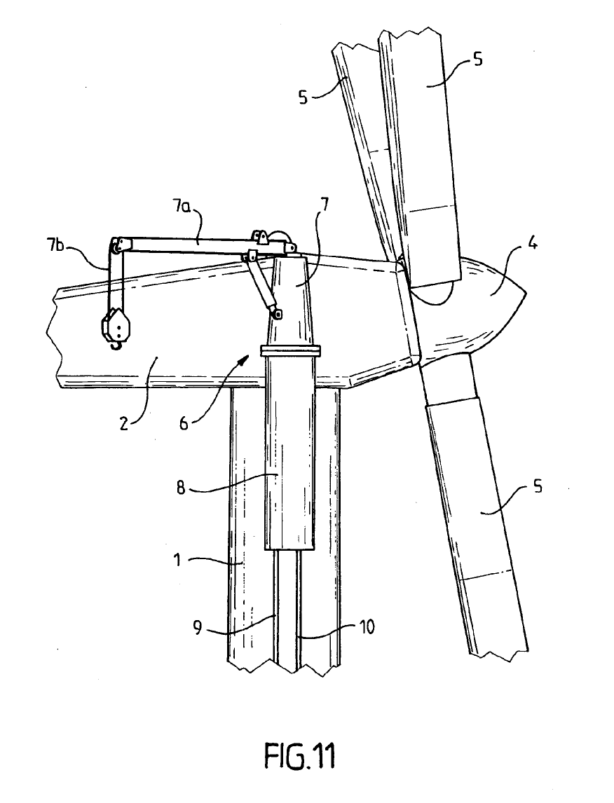

FIG. 10 is a partial cutaway side view that diagrammatically illustrates the crane-support unit at the beginning of its movement upward and a winch that is placed on the inside of the mast for lifting it from the crane-support unit;

FIG. 11 is a side view that diagrammatically illustrates the crane-support unit at the top of the mast before the beginning of the disassembly of the rotor;

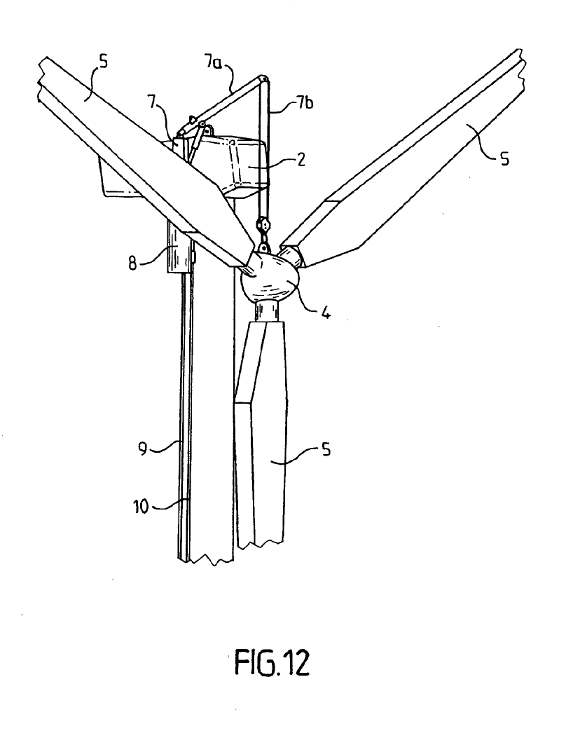

FIG. 12 is a perspective view that diagrammatically illustrates the rotor that is disengaged to be lowered to the ground using the crane-support unit;

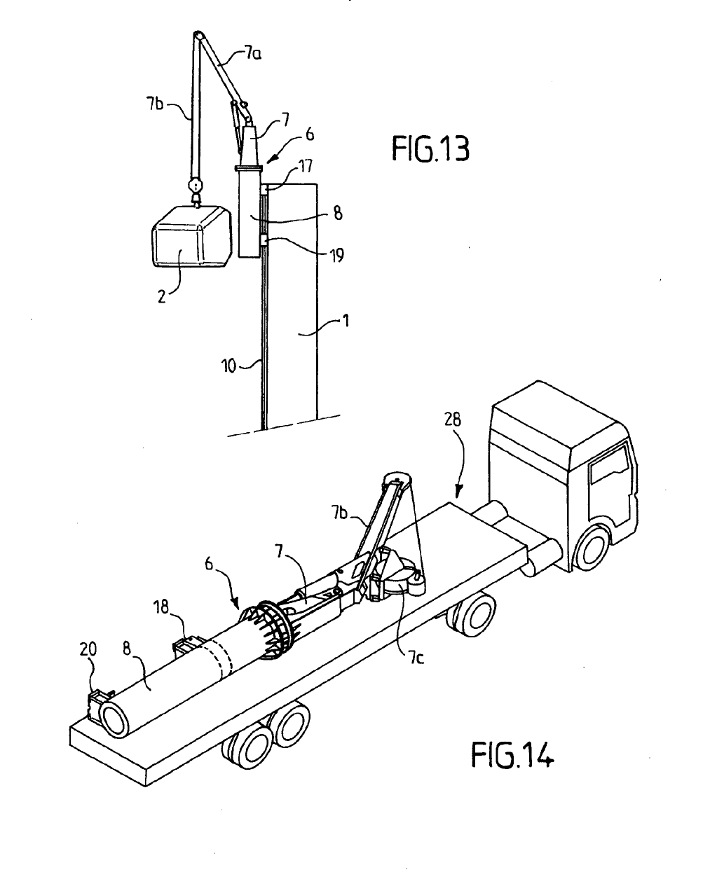

FIG. 13 is a view that is similar to the view of FIG. 12 that diagrammatically illustrates the nacelle that is disengaged to be lowered to the ground using the crane-support unit; and

FIG. 14 is a diagrammatic perspective view that illustrates the crane-support unit that is placed on a trailer in order to move it.

In the figures, the identical or equivalent elements will have the same references.

FIGS. 1 to 9 show the essential elements of the device for rapid disassembly according to the invention of a rotor and a nacelle from the mast of a windmill.

In a conventional manner in the art, the windmill comprises a mast 1 that carries a nacelle 2 in which a generator (not illustrated) is placed. The nacelle 2 is mounted to rotate on an orientation ring (not illustrated). The shaft of the generator is connected to a rotor 3 of the windmill, more specifically to a hub 4 on which the blades 5 of the rotor are fixed. All of these elements are well known in this technical field and since they do not relate directly to the invention, they will not be described in more detail here.

FIG. 1 shows a windmill mast 1 combined with a rapid disassembly device according to the invention. This device comprises a unit 6 that is formed by a crane 7 that is mounted to pivot on a support 8. The crane 7 comprises a jib 7a that is mounted to swing and that carries a lifting cable 7b that is wound onto a drum 7c that is placed at the rear end of the jib.

The support 8 is able to slide along the mast 1 on permanently fixed parallel guide rails 9, 10 on one side of the mast 1. These guide rails make it possible for the crane-support unit 6 to move along the mast 1 using lifting means.

These lifting means comprise a winch 11 that—in the variant illustrated in FIGS. 1, 3, 4 and 8—is placed on the outside of the mast 1, whereas in the variant that is illustrated in FIG. 10, it is placed on the inside of the latter.

The crane-support unit 6 is connected to the winch 11 by a cable 12 that runs over a first pulley 13 that is arranged at the top of the mast 1. In the variant where the winch is placed on the outside, the cable runs over a second pulley 14 by extending through an opening 15 that is made at the bottom of the mast 1. Of course, it is possible also to provide a return pulley at the top so that the cable descends approximately parallel to the shaft of the mast 1.

The attachment point 16 of the cable 12 to the crane-support unit 6 is found at the bottom of the support 8.

The rails 9, 10 advantageously have a T-shape so as to accommodate, by means of mating shapes, two pairs of holding elements 17 to 20 in the shape of a C provided on one side of the crane support 8.

On the low part of the mast 1, the rails have breaks formed by two pairs of free spaces 21, 22 making it possible to engage holding elements 17 to 20 on the rails and subsequently to release these elements from the latter.

The rapid disassembly device according to the invention also comprises means for locking the crane-support unit 6 at the top of the mast 1. These locking means comprise first locking elements provided on the crane support 8 and second locking elements 24 provided on the mast 1.

These first and second locking elements 23, 24 comprise plates that extend beyond the periphery of the support 8 or from the mast 1. These plates are equipped with holes 25 that can be aligned on one another when the crane support 8 is found at the top of the mast 1 so as to accommodate the locking rods 26.

The locking rods 26 are controlled by hydraulic means in the form of hydraulic jacks 27 that are part of an on-board hydraulic circuit (not shown) in the crane support 8.

The crane-support unit 6 comprises means for controlling the crane 7 that advantageously comprise remote-control means (not shown) that make it possible to control at a distance all of the functions of the crane 7 from the ground.

These remote control means also make it possible to control at a distance the locking means 23, 24, 26 of the crane-support unit 6, at least for the unlocking of these locking means. By contrast, the locking by the locking rods 26 can be triggered automatically when the crane-support unit 6 rises and is stopped there by stop means (not shown) on the mast 1 that stop the unit in a position in which the holes 25 that accommodate the rods 26 are aligned on one another.

Other stop means (not shown) can also be provided at the bottom of the mast to stop the crane-support unit 6 in a position in which the holding elements 17 to 20 of the unit can be released from the rails 9, 10.

The crane-support unit 6 is advantageously able to be placed on a transport vehicle 28 without prior disassembly of the crane-support unit. The jib 7a of the crane 7 in this case can extend slightly beyond the platform of the transport vehicle. In this manner, the crane-support unit 6 can be moved to be used on several windmills that are equipped with the disassembly device according to the invention.

According to one variant, the winch 11 constitutes a modular winch that can be attached by rapid connecting means to a mounting point that is provided close to the mast 1 of each windmill that is equipped with a disassembly device according to the invention. The winch 11 can thus be released from its connecting means to be transported with the crane-support unit 6 so as to be used on several windmills.

Furthermore, the on-board hydraulic means in the crane support 8 are in turn supplied electrically by means of an electric cable 29 that has an adequate length to connect the crane-support unit 6 to an electrical source (not shown) that is found at ground level.

The device for rapid disassembly of a rotor and a nacelle from the mast of a windmill operates according to the invention in the following manner.

Following a forecast of a strong hurricane that is likely to damage the rotor 3 and the nacelle 2 of a windmill that is equipped with permanently fixed guide rails 9, 10 on one side of the mast 1 and able to guide a unit 6 that is formed by a crane 7 that is mounted on a support 8, lifting means 11 to 14 that are at least partially integrated in the mast 1 of the windmill, and locking means 23 to 26 of the crane-support unit 6 at the top of the mast 1, the crane-support unit 6 is first transported before the windmill in question.

Then, the crane-support unit 6 is engaged on the rails 9, 10 and connected to the winch 11 by the cable 12 that runs over the first pulley 13 that is placed on top of the mast. The winch 11 can be fixed on the ground close to the mast 1, or else be permanently mounted on the inside of the latter. In the first case, it is necessary to provide a second pulley 14 at the bottom of the mast 1 and an opening 15 at the bottom of the latter for the passage of the cable 12. The winch can be a modular winch that can be used on several windmills that are equipped in the same manner.

The crane-support unit 6 is then hoisted to the top of the mast and locked in work position on the top of the mast.

Subsequently, the jib 7a of the crane 7 is placed above the rotor 3 and connected to the latter by a cable 7b of the jib 7. The rotor 3 is then disengaged from the nacelle 2 to be lowered and put on the ground.

The nacelle 2 is then disassembled in the same manner to be put on the ground. The crane-support unit 6 can then be lowered toward the ground and released from the guide rails 9, 10.

The rotor 3, the nacelle 2 and the crane-support unit itself 6 can thus be transported on a transport vehicle 28 to a reliable location to be sheltered from the hurricane.

The operations of the crane 7 at the top of the mast can be remote-controlled from the ground.

All of the disassembly operations of the rotor 3 and the nacelles 2 from a windmill take approximately 24 hours, which means that in general, there is time to disassemble the rotor 3 and the nacelle 2 from three or four windmills that are pre-equipped with the disassembly device according to the invention.

In the case of a windmill park that comprises a larger number of windmills (>4), it is necessary to use several crane-support units 6 and preferably several transport vehicles 28 or trailers for the simultaneous disassembly of several windmills.

Thanks to the invention, it is thus possible to disassemble the rotor and the nacelle rapidly from several windmills that are likely to be exposed to a major risk because of a strong hurricane that is forming. Contrary to what is currently the case, there is no longer need for a very powerful crane for this disassembly and in any case, such a crane is not in general immediately available for carrying out this disassembly, which should be done within an extremely short period of time. The invention makes it possible to begin disassembly as soon as there is a strong hurricane forecast, even in the case where the windmills are installed in mountainous regions or on islands or in other locations that are difficult to access.

Furthermore, it is obvious that the disassembly device according to the invention can also be useful for maintenance and repair work; in this case, the crane-support unit 6 can quite obviously remain in its locked position at the top of the mast 1 for the necessary time for these works.

The disassembly device according to the invention can also be used during the last assembly phase of a windmill so as to install the nacelle 2 at the top of the mast 1 and then the rotor 3 on the latter. The height of the windmill is thus unimportant, and, using the device according to the invention, it is possible to reach even greater heights.

The invention also provides another economic advantage since the cost of the device of the invention is clearly less than the purchase price of a high-capacity crane.

The costs for stowing the equipment in the event of bad weather or difficult meteorological conditions are also reduced.

1. Device for rapid disassembly of a rotor (3) and a nacelle (2) from the mast (1) of a windmill, comprising a crane-support unit (6) that is formed by a crane (7) that is mounted on a support (8), whereby said crane-support unit (6) is able to move along the mast (1) using lifting means (11 to 14), and locking means (23 to 26) of said crane-support unit (6) at the top of the mast (1), characterized by the fact that said crane-support unit (6) is able to slide on guide rails (9, 10) that are fixed permanently on one side of the mast, that said lifting means (11 to 14) are at least partially integrated in the latter and comprise a winch (11) that is arranged at the bottom of said mast (1), and through which a cable (12) runs over a first return pulley (13) that is permanently fixed at the top of the latter.

2. Device according to claim 1, wherein said winch (11) is placed on the inside of the mast (1).

3. Device according to claim 1, wherein said winch (11) is a modular winch that can be fixed by rapid connecting means to a mounting point that is provided close to the mast (1) of each windmill that is equipped with a device of the same type, and wherein said cable (12) extends via an opening (15) into the lower part of the mast (1), and the first runs over a second return pulley (14) that is permanently fixed on the inside of the mast (1), in the lower part of the latter.

4. Device according to claim 1, wherein stop means are provided on the top and/or on the bottom of the mast (1) so as to stop said crane-support unit (6) in a locking position or to operate the lowering of the rotor (3) and the nacelle (2) and/or in a position for separating said crane-support unit (6) from the mast (1).

5. Device according to claim 1, wherein said rails (9, 10) have a T shape so as to accommodate, by means of mating shapes, holding elements (17 to 20) in the shape of a C provided on one side of said support (8).

6. Device according to claim 1, wherein said locking means (23 to 26) comprise first locking elements (23) that are provided on said support (8) and are able to work with second locking elements (24) that are provided on said mast (1).

7. Device according to claim 6, wherein said first and second locking elements (23, 24) comprise plates that extend beyond the periphery of said support or from said mast and that are equipped with holes (25) that can be aligned on one another when said support (8) is found at the top of the mast, and locking rods (26) that can be inserted into said aligned holes (25).

8. Device according to claim 7, wherein said locking rods (26) are controlled by hydraulic means that are part of an on-board hydraulic circuit on said support (8).

9. Device according to claim 1, wherein said crane-support unit (6) comprises means for controlling the crane (7) comprising remote control means that make it possible to control at a distance all of the crane's functions.

10. Device according to claim 9, wherein said remote control means also make it possible to control at a distance said locking means (23 to 26) of said crane-support unit (6), at least for unlocking the latter.

11. Device according to claim 1, wherein said crane-support unit (6) is able to be placed without prior disassembly on a transport vehicle (28) so as to be used on several windmills that are equipped with said rapid disassembly device.

12. Windmill, wherein it is equipped with a device according to claim 1.

13. Process for rapid disassembly of a rotor (3) and a nacelle (2) of the mast (1) of a windmill, wherein it comprises the phases that consist in:
Providing on the windmill, during the construction of the latter, guide rails (9, 10) that are permanently fixed on one side of the mast (1) and able to guide a crane-support unit (6) that is formed by a crane (7) that is mounted on a support (8);
Integrating in the mast (1), at least partially, lifting means (11 to 14) of said crane-support unit comprising a winch (11) that is placed at the bottom of said mast (10 and whose cable runs over a first return pulley (13) that is permanently fixed on the top of the mast (1);
Providing locking means (23 to 26) for said crane-support unit (6) at the top of the mast (1); and during said rapid disassembly of the rotor (3) and the nacelle (2):
Connecting said crane-support unit (6) to said guide rails (9, 10) at the bottom of the mast (1);
Hoisting said crane-support unit (6) to the top of the mast (1) using said lifting means (11 to 14);
Locking said crane-support unit (6) at the top of the mast (1) using said locking means (23 to 26);
Placing the jib (7a) of the crane (7) above the rotor (3) and connecting the latter to a cable (7b) of the jib;
Disengaging the rotor (3) from the nacelle (2) and lowering it using the crane (7) to put it on the ground;
Placing the jib (7a) of the crane (7) above the nacelle (2) and connecting the latter to the cable (12) of the jib (7a);
Disengaging the nacelle (2) from the mast (1) and lowering it using the crane (7) to put it on the ground;
and, after the time the rotor (3) and the nacelle (2) have to remain on the ground:
Reassembling the nacelle (2) and the rotor (3) using the crane (7) in reverse order.

14. Process for rapid disassembly of a rotor (3) and a nacelle (2) from the mast (1) of a windmill according to claim 13, wherein it also comprises the phases that consist in:
Releasing said crane-support unit (6) from said locking means (23 to 26) to make it descend toward the ground while keeping the rotor (3) and the nacelle (2) on the ground;
Separating said unit from said guide rails (9, 10).

15. Process for rapid disassembly of a rotor (3) and a nacelle (2) from the mast (1) of a windmill according to claim 14, wherein it also consists in:
Placing said crane-support unit (6) on a transport vehicle (28);
Transporting said crane-support unit (6) having at least one other windmill that is equipped with the same rapid disassembly device and carrying out in the same way the disassembly of the rotor (3) and the nacelle (2) from the latter;
and after the time the rotor (3) and the nacelle (2) have to remain on the ground respectively:
Reassembling the nacelle (2) and the rotor (3) in reverse order by transporting said crane-support unit (6) between the thus disassembled windmills.

16. Process for rapid disassembly of a rotor (3) and a nacelle (2) from the mast (1) of a windmill according to claim 13, wherein a modular winch (11) that is part of said lifting means (11 to 14) and is able to be fixed by rapid connecting means at a mounting point provided on the exterior of the mast (1) of each windmill of the same type is used, and wherein a second return pulley (14) is permanently fixed on the inside of the mast (1), in the lower part of the latter, and wherein a cable (12) is passed from said modular winch (11) through an opening (15) at the bottom of the mast (1).

17. Rapid disassembly process of a rotor (3) and a nacelle (2) from the mast (1) of a windmill according to claim 13, wherein all of the operations of the crane (7) are remote-controlled.
